(19) United States
(12) Patent Application Publication
(10) Pub. No.: US 2013/0029238 A1
(43) Pub. Date: Jan. 31, 2013

(54) STARTUP CONTROL DEVICE AND METHOD FOR FUEL CELL SYSTEM

(71) Applicants: Se Joon Im, Yongin (KR); Jae Jun Ko, Gunpo (KR); Young Min Kim, Suwon (KR); Ik Jae Son, Yongin (KR); Jong Hyun Lee, Yongin (KR)

(72) Inventors: Se Joon Im, Yongin (KR); Jae Jun Ko, Gunpo (KR); Young Min Kim, Suwon (KR); Ik Jae Son, Yongin (KR); Jong Hyun Lee, Yongin (KR)

(73) Assignee: HYUNDAI MOTOR COMPANY, Seoul (KR)

(21) Appl. No.: 13/195,261

(22) Filed: Aug. 1, 2011

(30) Foreign Application Priority Data
Dec. 3, 2010 (KR) 10-2010-0122535

(51) Int. Cl. H01M 8/04

(52) U.S. Cl. 429/429; 429/444

(57) ABSTRACT

The present invention provides a startup control device and method for a fuel cell system. The startup control device includes a concentration meter, a hydrogen feed rate controller, and a controller. The concentration meter measures the concentration of oxygen located in the anode of a fuel cell stack. The hydrogen feed rate controller is disposed at an inlet of the anode. The controller receives an oxygen concentration signal value from the concentration meter while controlling the hydrogen feed rate controller to adjust a hydrogen feed rate to the anode.

### CROSS-REFERENCE TO RELATED APPLICATION

This application claims under 35 U.S.C. §119(a) the benefit of Korean Patent Application No. 10-2010-0122535 filed Dec. 3, 2010, the entire contents of which are incorporated herein by reference.

### BACKGROUND

(a) Technical Field

The present invention relates to a startup control device and method for a fuel cell system. In particular, it relates to a startup control device and method for a fuel cell system that can reduce the time required to form an interface between hydrogen and air remaining on the anode and prevent an overvoltage from being generated according to formation of the interface, by controlling the feed rate of hydrogen supplied to the anode upon startup of the fuel cell system.

(b) Background Art

In a stopped state of a fuel cell system which includes a fuel cell stack, air usually flows into the cathode of the stack, and then flows into and resides in the anode by diffusion through a gas diffusion layer and an electrolyte membrane. That is, when the fuel cell system including the fuel cell stack, i.e., a fuel cell vehicle mounted with the fuel cell system stops, air and hydrogen supply into a fuel cell is interfered. However, when the stopped state lasts for a long time, hydrogen remaining in the anode may flow to the cathode through an electrolyte membrane, and the pressure of the anode may become lower than the pressure of the cathode. As a result, a negative pressure is generated in the anode with an inlet and an outlet clogged, and thus oxygen present in the cathode is diffused into the anode due to a pressure difference between the anode and the cathode.

Upon startup of a typical fuel cell system from its stopped state, an air supply unit is driven to supply air to the cathode of the stack, and at the same time, hydrogen is supplied from a hydrogen tank to the anode of the stack.

Also upon startup of the typical fuel cell system, when hydrogen is supplied to the anode, supplied hydrogen meets air present in the anode to form an interface between hydrogen and air (oxygen), which forms an overvoltage at the cathode-side according to the formation of the interface between hydrogen and oxygen.

When there is a generation of overvoltage in the cathode, it may result in the erosion of the cathode electrode. This will deteriorate the stack performance after several tens or hundreds of cycles. That is, when the fuel cell system starts, hydrogen is normally supplied to the anode to form an interface with the remaining oxygen and at the same time induce a chemical reaction, which will generate high potential in the cathode to cause carbon erosion. As a result, the carbon catalyst in the cathode is reduced, thereby reducing its activation leading to deterioration of the fuel cell performance. The deterioration then results in a drop in the voltage generated in the fuel cell thereby lowering its durability.

As a related art for preventing generation of an overvoltage upon startup of the fuel cell system, there has been used a process of dropping a voltage using a dummy load connection such as resistance. However, when fuel is not supplied in a uniform fashion, a reverse voltage may be generated in a cell of a stack, and may cause fatal deterioration in the performance of the stack.

Accordingly, it is a vital process to improve to the durability of the fuel cell stack to prevent or minimize the overvoltage caused by the interface between hydrogen and air (oxygen), which is formed by air (oxygen) flowed into the anode upon startup of the fuel cell system from its stopped state.

The above information disclosed in this Background section is only for enhancement of understanding of the background of the invention and therefore it may contain information that does not form the prior art that is already known to a person of ordinary skill in the art.

### SUMMARY OF THE DISCLOSURE

The present invention provides a startup control device and method for a fuel cell system, which can reduce the time required to form an interface with air remaining on the anode, prevent generation of an overvoltage according to the formation of the interface, and reduce unnecessary hydrogen consumption, by adjusting the feed rate of hydrogen supplied to the anode according to the concentration of oxygen located in the anode when the fuel cell system starts from its stopped state.

In one aspect, the present invention provides a startup control device for a fuel cell system, comprising: a concentration meter measuring a concentration of oxygen present in an anode of a fuel cell stack; a hydrogen feed rate controller disposed at an inlet of the anode; and a controller receiving an oxygen concentration signal value from the concentration meter while controlling the hydrogen feed rate controller to adjust a hydrogen feed rate to the anode.

In another aspect, the present invention provides a startup control method for a fuel cell system, comprising: measuring a concentration of oxygen present in an anode of a fuel cell stack upon startup of the fuel cell system; and controlling a hydrogen feed rate to the anode according to the concentration of oxygen.

In a preferred embodiment, the hydrogen feed rate may be adjusted to an increased (e.g., high) rate if the concentration of oxygen is equal to or greater than a reference value.

In another preferred embodiment, the hydrogen feed rate may be adjusted to a normal (or lower) rate if the concentration of oxygen is less than a reference value.

Other aspects and preferred embodiments of the invention are discussed herein.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a diagram illustrating a startup control method for a fuel cell system according to an embodiment of the present invention;

FIGS. 2a through 2c are graphs illustrating V-I curves showing cell voltage changes measured by controlling the feed rate of hydrogen supplied to the anode using a startup control method for a fuel cell system according to an embodiment of the present invention; and

FIGS. 3a through 3d are graphs illustrating V-I curves showing cell voltage changes according to the amount of air remaining in the anode upon startup of a fuel cell system.

Reference numerals set forth in the Drawings includes reference to the following elements as further discussed below:

| | |
|---|---|
| 10: fuel cell stack | 12: anode |
| 14: cathode | 16: concentration meter |
| 18: hydrogen feed rate controller | 20: controller |
| 22, 24, 26, and 28: valve | |

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

Also, it is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Hereinafter, exemplary embodiments of the present invention will be described in detail with reference to the accompanying drawings.

Upon startup of a fuel cell system, as the concentration of oxygen in the anode of a fuel cell stack increases, a higher overvoltage may be generated. Accordingly, the erosion of the cathode electrode may be accelerated, and the activation of the cathode may be reduced due to the loss of its carbon catalyst, causing deterioration that causes a performance reduction of a fuel cell.

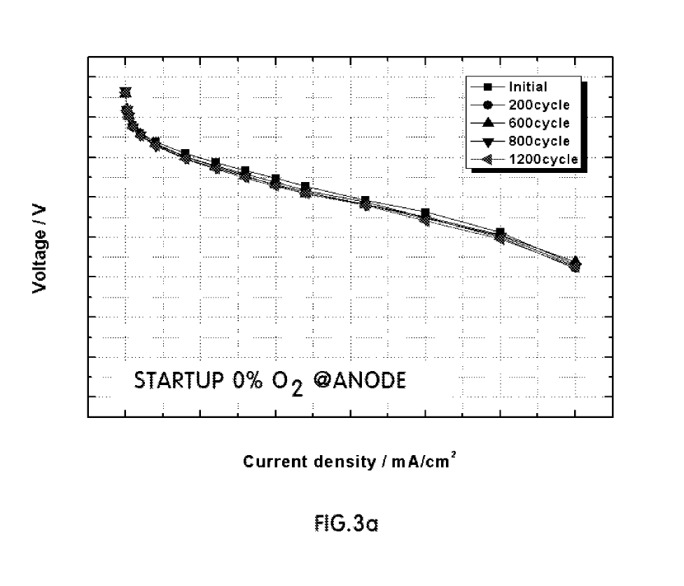

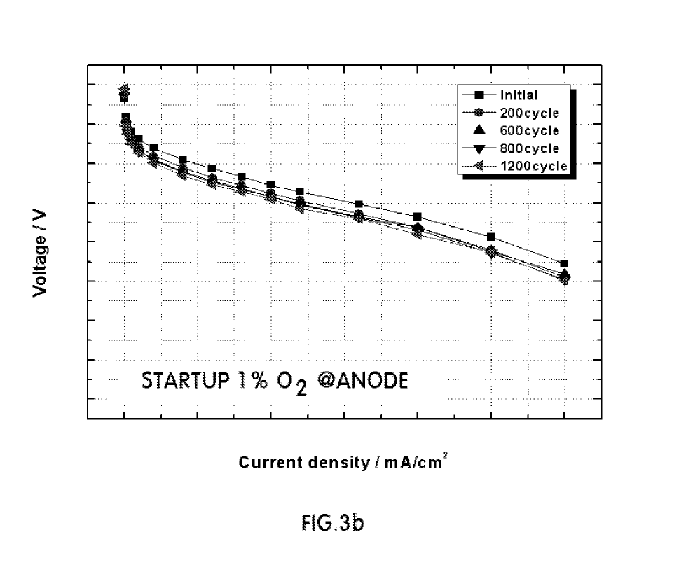

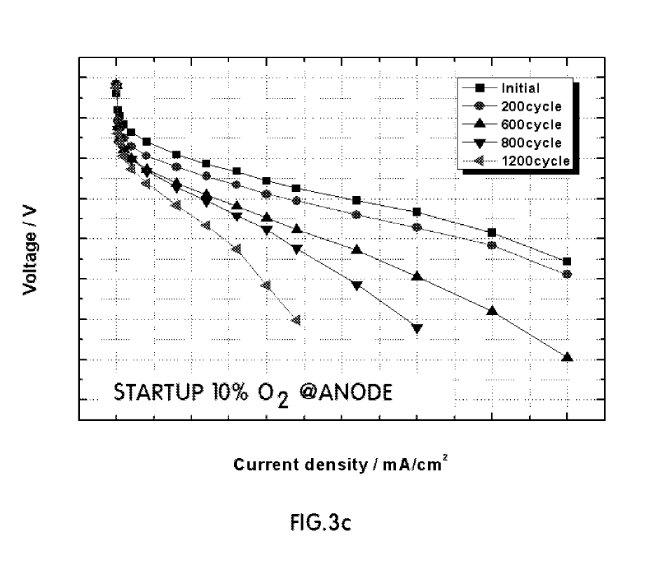

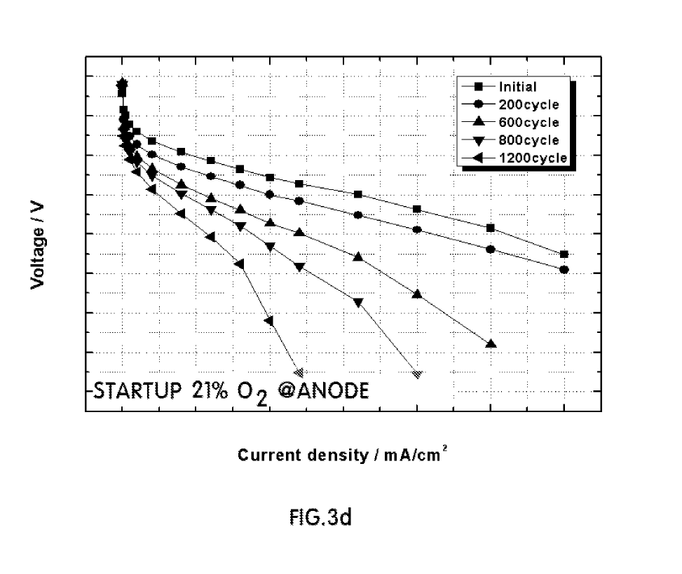

As a detailed example, as shown in FIGS. 3a and 3b, when the oxygen concentration of the anode is about 0% or about 1%, the cell voltage does not drop despite several thousands of cycles of start and stop. However, as shown in FIGS. 3c and 3d, when the oxygen concentration of the anode is about 10% or about 20%, the cell voltage drops as the cycle of start and stop is repeated. As a result, this may reduce the durability of the fuel cell system and instability of the whole system, and may ultimately cause a frequent shutdown of the system.

The present invention is focused reducing the erosion of a cathode electrode that is generated upon startup of a fuel cell system. This can be accomplished by feeding hydrogen to the anode of a stack at a higher rate, in order to reduce the time required to form an interface between hydrogen and air (oxygen) that is formed in the anode.

However, increasing the feed rate of the hydrogen whenever the fuel cell system starts may become a factor that increases hydrogen consumption, thereby reducing hydrogen fuel efficiency.

Accordingly, in order to prevent superfluously excessive hydrogen consumption upon startup of the fuel cell system, only when the concentration of oxygen flowing into the anode is equal to or greater than a specific reference value (e.g., 10% oxygen at the anode), hydrogen may be supplied to the anode at an increased (e.g., high) rate. However, when the concentration of oxygen is less than the specific value (e.g., 1% oxygen at the anode), hydrogen may be supplied at a normal (or lower) rate. As used herein, a “normal” rate is a supply rate that is conventional for similar types of fuel cell systems, and an “increased” rate is a supply rate that is greater than the conventional normal rate. Note also that the specific values for oxygen concentration are merely illustrative examples, and are not meant to limit the scope of the present invention.

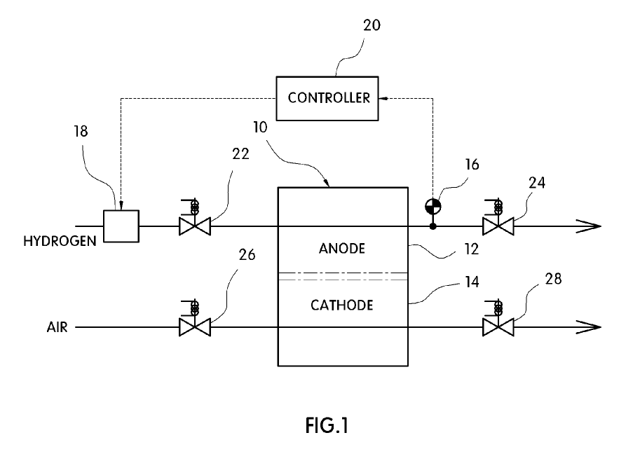

As shown in FIG. 1, the configuration for the startup of the fuel cell system according to an embodiment of the present invention may include a concentration meter 16 for measuring the concentration of oxygen present in an anode 12 of a fuel cell stack 10, a hydrogen feed rate controller 18 disposed at the inlet of the anode 12 (e.g., at an end of the inlet), a controller 20 for receiving a signal value of the oxygen concentration from the concentration meter 16 to control the hydrogen feed rate to the anode 12 upon startup of the fuel cell system, and at the same time controlling the operation of the hydrogen feed rate controller 18.

In one embodiment, the hydrogen feed rate controller 18 may include a high-pressure pump for changing the pressure of hydrogen into a high pressure or changing the flow rate of hydrogen, or a typical flow rate controller such as a flow rate control valve for changing the flux of hydrogen.

In this case, valves 22 and 24 installed at the inlet and outlet of the anode 12 of the stack 10, and valves 26 and 28 installed at the inlet and outlet of the cathode 14 may be closed to block gases (hydrogen and air) from be supplied into the stack when the fuel cell system stops. However, while the stopped state lasts for a long time, a very small amount of air may flow into the stack. That is, the inflow of air cannot be prevented completely.

Hereinafter, a startup control method for a fuel cell system according to an embodiment of the present invention will be described as follows.

In the stopped state of the fuel cell system, air may flow into the cathode of a fuel cell stack, and then air may also flow into and exist in the anode by a diffusion process through a gas diffusion layer and an electrolyte membrane.

In this case, when the fuel cell system starts, the concentration of oxygen in the anode 12 may be measured by the concentration meter 16, and then the measured concentration may be transmitted to the controller 20 as a signal.

Next, the controller 20 may control the operation of the hydrogen feed rate controller 18 disposed at the end of the inlet of the anode 12, according to the concentration of oxygen, in order to control the feed rate of hydrogen to the anode 12.

For example, when the hydrogen feed rate controller 18 is applied as a pump, the controller 20 may control the revolutions per minute (RPM) of the pump to feed hydrogen to the anode 12 at a high pressure or rate, or may control the RPM of the pump to feed hydrogen at a normal rate.

Thus, when the concentration of oxygen is equal to or greater than a reference value, the hydrogen feed rate may be adjusted to an increased (e.g., high) rate. Accordingly, the time taken to form an interface between hydrogen and air formed in the anode due to the high flow rate and supply increase of hydrogen may be considerably shortened, thereby preventing the generation of an overvoltage in the cathode and maintaining the durability of the cathode electrode.

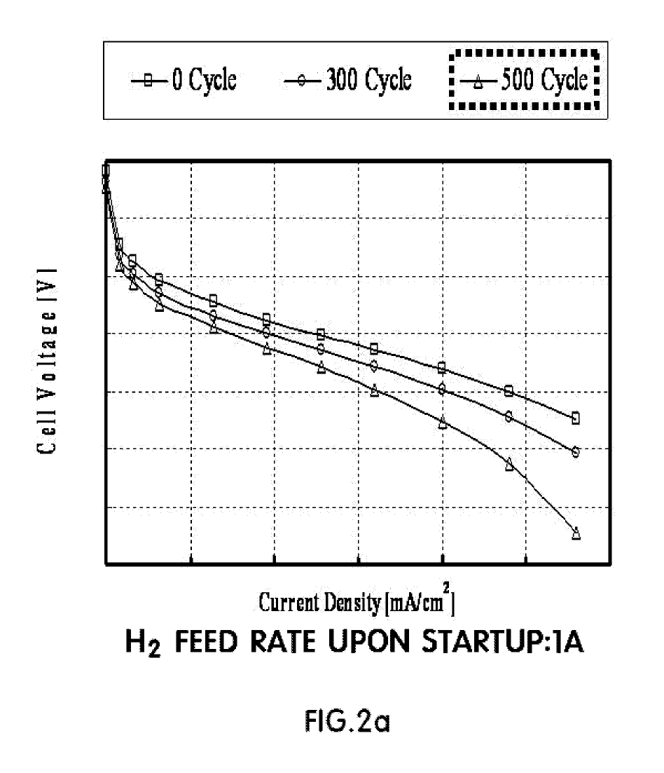

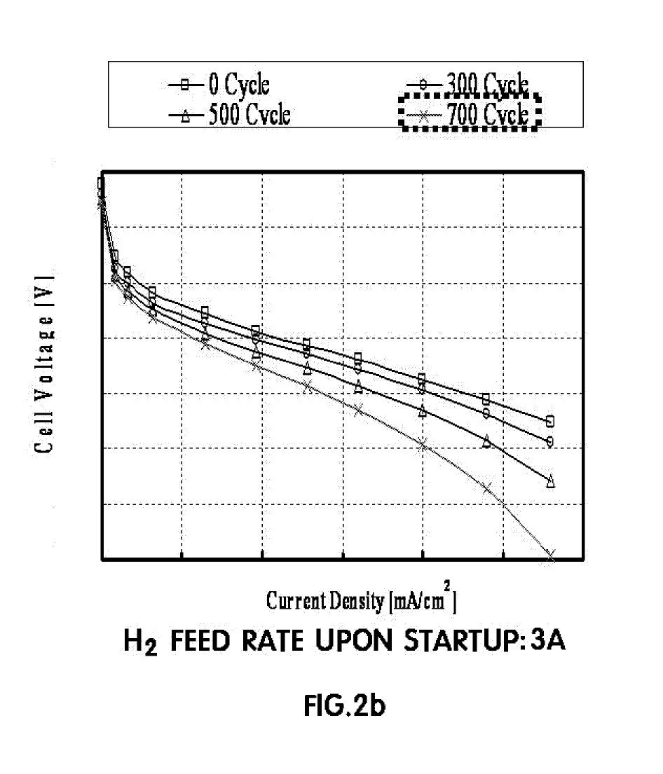

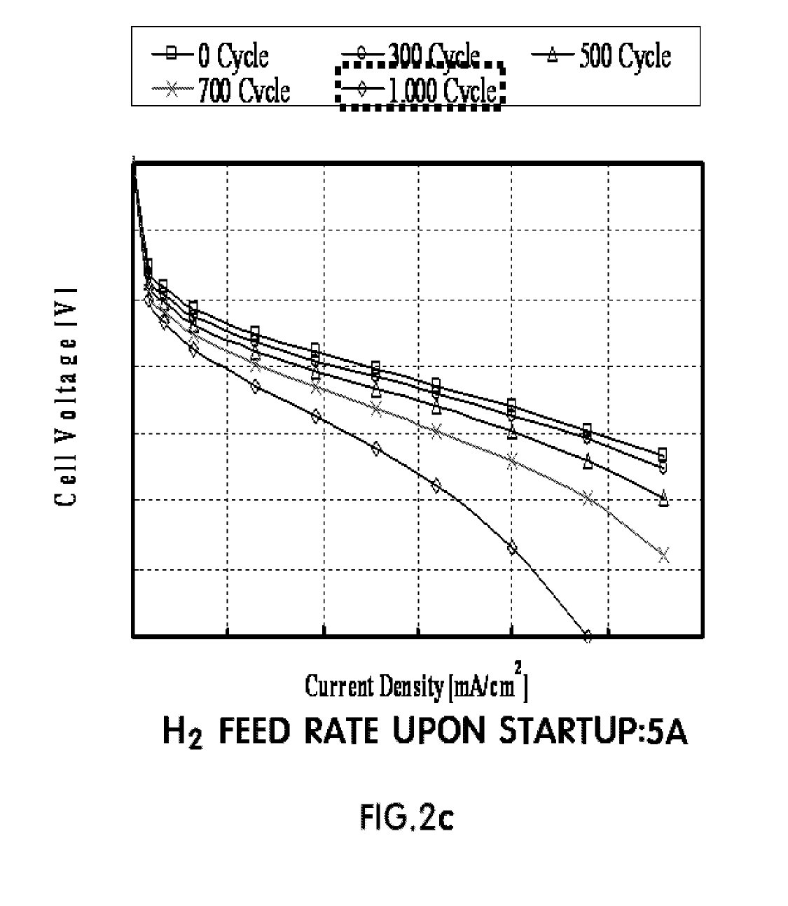

In an experimental example, the cell voltage has been measured for each hydrogen feed rate while the fuel cell system repeats a cycle of its start and stop. That is, the start and stop of the fuel cell system were repeated for about several hundreds or thousands of cycles. The cell voltage was measured while the hydrogen feed rate was being maintained at a normal rate A or “1A” (see FIG. 2a) upon startup, at a rate “3A” (see FIG. 2b) about three times as large as the normal rate, and at a rate “5A” (see FIG. 2c) about five times as large as the normal rate, respectively. As a result, when the hydrogen feed rate was low, a cell voltage drop was observed in about several hundreds of cycles. On the other hand, when the hydrogen feed rate was higher, a cell voltage drop was observed in about several hundreds of cycles. As the hydrogen feed rate increased, the cell voltage drop was observed in about several hundreds of cycles and the performance deterioration slowly progressed.

Also, when the concentration of oxygen is less than the reference value, the hydrogen feed rate to the anode may be adjusted to a lower rate, thereby reducing unnecessary hydrogen consumption. That is, when the concentration of air (oxygen) remaining in the anode does not influence the erosion of the cathode electrode, the hydrogen feed rate may be maintained at the normal rate without unnecessarily feeding hydrogen at a high rate, thereby reducing the hydrogen consumption.

A startup control device and method for a fuel cell system according to embodiments of the present invention, can minimize formation of an interface between hydrogen and air and prevent an overvoltage from being generated in the cathode according to the formation of the interface, by feeding hydrogen to the anode at a high rate upon startup after air flows into the anode of a stack upon stop of the fuel cell system.

As the generation of the overvoltage in the cathode is minimized, the durability of the cathode electrode can be maintained.

Particularly, it is possible to prevent hydrogen from being unnecessarily consumed, by measuring the concentration of oxygen located in the anode and controlling the feed rate of hydrogen according to the measured concentration of oxygen.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A startup control device for a fuel cell system comprising:
a concentration meter configured to measure a concentration of oxygen present in an anode of a fuel cell stack;
a hydrogen feed rate controller disposed at an inlet of the anode; and
a controller configured to receive an oxygen concentration signal value from the concentration meter and to control the hydrogen feed rate controller to adjust a hydrogen feed rate to the anode.

2. The startup control device of claim 1, wherein the hydrogen feed rate is adjusted to an increased rate greater than a normal rate if the concentration of oxygen is equal to or greater than a reference value.

3. The startup control device of claim 2, wherein the increased rate is three times the normal rate.

4. The startup control device of claim 2, wherein the increased rate is five times the normal rate.

5. The startup control device of claim 1, wherein the hydrogen feed rate is adjusted to a normal rate if the concentration of oxygen is less than a reference value.

6. A startup control method for a fuel cell system comprising:
measuring a concentration of oxygen present in an anode of a fuel cell stack upon startup of the fuel cell system; and
controlling a hydrogen feed rate to the anode according to the concentration of oxygen.

7. The startup control method of claim 6, wherein controlling the hydrogen feed rate comprises: adjusting the hydrogen feed rate to an increased rate greater than a normal rate if the concentration of oxygen is equal to or greater than a reference value.

8. The startup control method of claim 7, wherein the increased rate is three times the normal rate.

9. The startup control method of claim 7, wherein the increased rate is five times the normal rate.

10. The startup control method of claim 7, wherein controlling the hydrogen feed rate comprises: adjusting the hydrogen feed rate to a normal rate if the concentration of oxygen is less than a reference value.

11. A system, comprising:
a fuel cell stack having an anode and a cathode;
a concentration meter configured to measure a concentration of oxygen present in the anode of the fuel cell stack;
a hydrogen feed rate controller disposed at an inlet of the anode; and
a controller configured to receive an oxygen concentration signal value from the concentration meter and to control the hydrogen feed rate controller to adjust a hydrogen feed rate to the anode.

12. The system of claim 11, wherein the hydrogen feed rate is adjusted to an increased rate greater than a normal rate if the concentration of oxygen is equal to or greater than a reference value.

13. The system of claim 12, wherein the increased rate is three times the normal rate.

14. The system of claim 12, wherein the increased rate is five times the normal rate.

15. The system of claim 11, wherein the hydrogen feed rate is adjusted to a normal rate if the concentration of oxygen is less than a reference value.
